(19) United States
(12) Patent Application Publication
(10) Pub. No.: US 2004/0111804 A1
(43) Pub. Date: Jun. 17, 2004

(54) Tool structure having drilling, chamfering and locking functions

(76) Inventors: Wei-Chuan Fan-Chiang, Taichung Hsien (TW); Mu-Mau Tseng, Taichung Hsien (TW); Shih-Yueh Chen, Taichung Hsien (TW)

Correspondence Address: CHARLES E. BAXLEY, ESQUIRE, Hart, Baxley, Daniels & Holton, 59 John St, 5 Fl, New York, NY, 10038, US

(21) Appl. No.: 10/352,593

(22) Filed: Jan. 27, 2003

(30) Foreign Application Priority Data
Dec. 16, 2002 (TW) 091220385

(51) Int. Cl. B25B 15/00

(52) U.S. Cl. 7/165

(57) ABSTRACT

A tool structure having drilling, chamfering and locking functions includes a quick clamping head, and a tool mounted on the quick clamping head. The tool has a first end formed with a chamfered portion and a drilling head secured on the chamfered portion, and a second end formed with a locking portion. Thus, the tool co-operates with the quick clamping head to perform the locking, chamfering and drilling work, thereby facilitating the user operating the tool, and thereby enhancing the working efficiency.

### BACKGROUND OF THE INVENTION

1. Field of the Invention

The present invention relates to a tool structure having drilling, chamfering and locking functions, and more particularly to a tool structure having drilling, chamfering and locking functions, wherein the tool co-operates with the quick clamping head to perform the locking, chamfering and drilling work, thereby facilitating the user operating the tool, and thereby enhancing the working efficiency.

2. Description of the Related Art

In assembly of two wooden plates, each of the two wooden plates is formed with a combination hole for screwing of a screw, so that the two wooden plates can be combined together. As shown in FIG. 1, each of the two wooden plates 12 is formed with a combination hole 121. The screw 11 has a head 111, so that one of the two wooden plates 12 is formed with a chamfered portion 122 for receiving the head 111 of the screw 11. Thus, the user has to provide an electric drilling machine which co-operates with a first tool head to perform the drilling work, and co-operates with a second tool head to perform the chamfering work. In addition, the electric drilling machine has to co-operate with a third tool head to perform the locking work for screwing and locking the screw 11, thereby causing inconvenience to the user in operation, and thereby decreasing the working efficiency.

### SUMMARY OF THE INVENTION

The primary objective of the present invention is to provide a tool structure having drilling, chamfering and locking functions, wherein the tool co-operates with the quick clamping head to perform the locking, chamfering and drilling work, thereby facilitating the user operating the tool, and thereby enhancing the working efficiency.

Another objective of the present invention is to provide a tool structure having drilling, chamfering and locking functions, wherein the tool is dual-directionally and interchangeably mounted on the quick clamping head, so that the tool can be mounted on and detached from the quick clamping head easily and conveniently, thereby facilitating the user operating the tool.

A further objective of the present invention is to provide a tool structure having drilling, chamfering and locking functions, wherein the drilling and chamfering procedures are accomplished simultaneously, thereby enhancing the working efficiency.

In accordance with the present invention, there is provided a tool structure having drilling, chamfering and locking functions, comprising a quick clamping head, and a tool mounted on the quick clamping head, wherein:

the tool has a first end formed with a chamfered portion, the tool includes a drilling head secured on the chamfered portion, the tool has a second end formed with a locking portion;

the chamfered portion and the drilling head of the tool are detachably mounted on the quick clamping head; and

the locking portion of the tool is detachably mounted on the quick clamping head.

Further benefits and advantages of the present invention will become apparent after a careful reading of the detailed description with appropriate reference to the accompanying drawings.

### BRIEF DESCRIPTION OF THE DRAWINGS

FIG. 1 is a side plan cross-sectional assembly view showing combination of two wooden plates with a screw in accordance with the prior art;

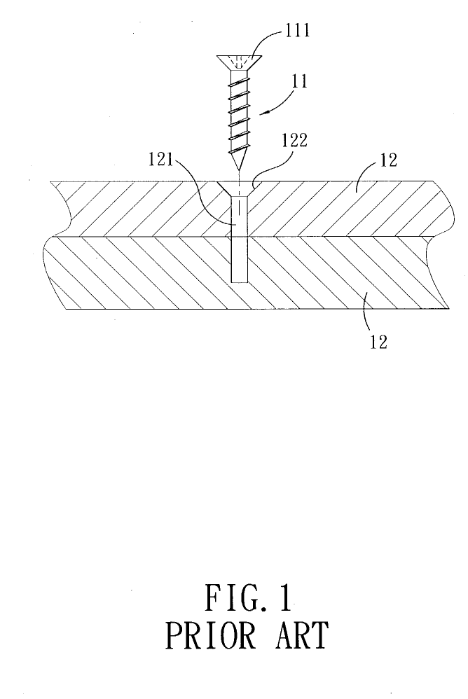

FIG. 2 is a perspective view of the tool of a tool structure having drilling, chamfering and locking functions in accordance with a preferred embodiment of the present invention;

FIG. 3 is a side plan exploded cross-sectional view of the tool structure having drilling, chamfering and locking functions in accordance with the preferred embodiment of the present invention;

FIG. 4 is an assembly view of the tool structure having drilling, chamfering and locking functions as shown in FIG. 3;

FIG. 5 is an assembly view of the tool structure having drilling, chamfering and locking functions as shown in FIG. 3;

FIG. 6 is a schematic operational view of the tool structure having drilling, chamfering and locking functions as shown in FIG. 5; and

FIG. 7 is an exploded perspective view of the tool of a tool structure having drilling, chamfering and locking functions in accordance with another embodiment of the present invention.

### DETAILED DESCRIPTION OF THE INVENTION

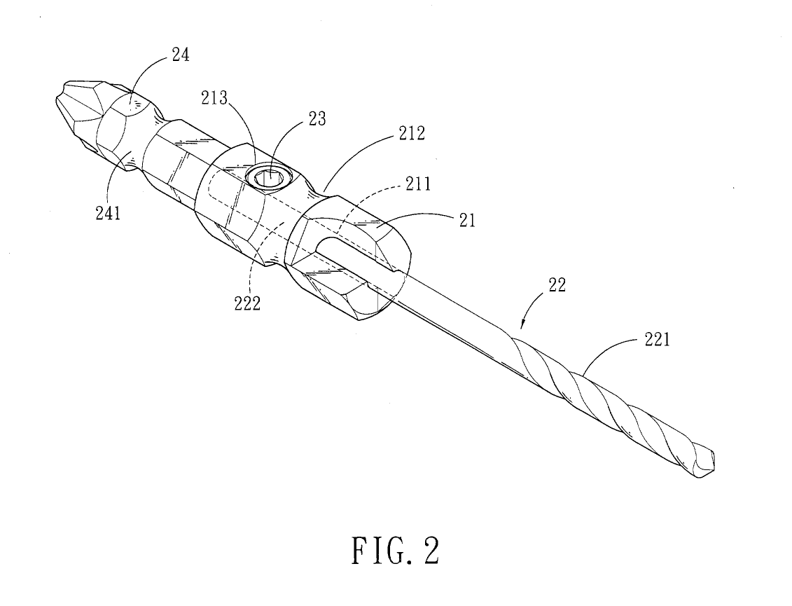

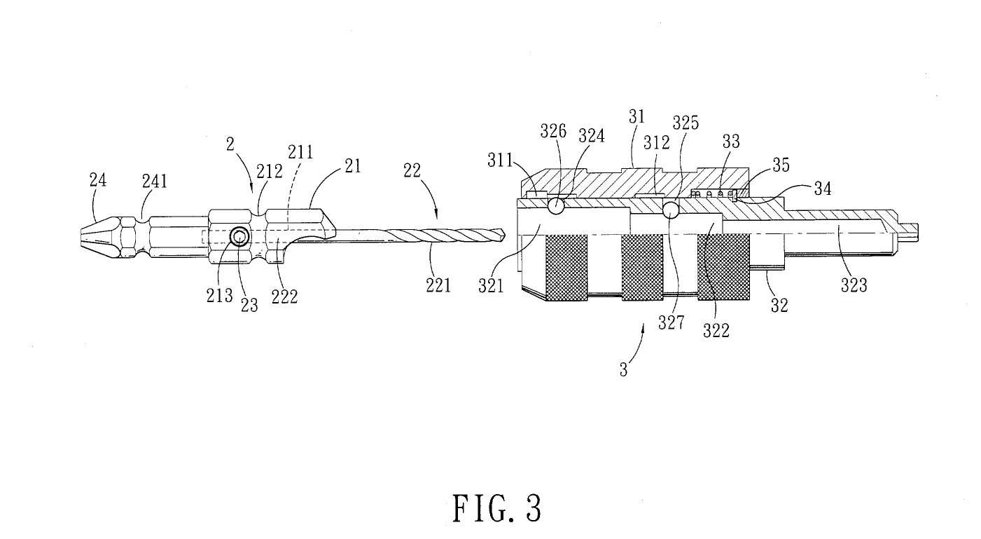

Referring to the drawings and initially to FIGS. 2 and 3, a tool structure having drilling, chamfering and locking functions in accordance with a preferred embodiment of the present invention comprises a quick clamping head 3, and a tool 2 dual-directionally and interchangeably mounted on the quick clamping head 3.

The tool 2 has a polygonal (preferably hexagonal) cross-section. The tool 2 has a first end formed with a chamfered portion 21. The chamfered portion 21 of the tool 2 has a center formed with an axially extended receiving recess 211. The chamfered portion 21 of the tool 2 has an outer wall formed with an annular first locking groove 212. The chamfered portion 21 of the tool 2 has a periphery formed with a fixing hole 213 located adjacent to the first locking groove 212 and communicated with the receiving recess 211.

The tool 2 includes a drilling head 22 secured on the chamfered portion 21. The drilling head 22 has a first end formed with an operation portion 221 protruding outward from the chamfered portion 21 and a second end formed with an insertion portion 222 inserted into the receiving recess 211. The tool 2 further includes a positioning member 23 secured in the fixing hole 213 and urged on the insertion portion 222 of the drilling head 22, thereby positioning the drilling head 22 on the chamfered portion 21.

The tool 2 has a second end formed with a locking portion 24. Preferably, the locking portion 24 of the tool 2 has a cruciform shape. The locking portion 24 of the tool 2 has an outer wall formed with an annular second locking groove 241.

The quick clamping head 3 includes a main body 32, and a sleeve 31 movably mounted on the main body 32.

The main body 32 of the quick clamping head 3 has an inner wall formed with a polygonal (preferably hexagonal) step-shaped receiving channel, so that the tool 2 is dual-directionally and interchangeably mounted on the quick clamping head 3.

The receiving channel of the main body 32 of the quick clamping head 3 has a first channel section 321, a second channel section 322, and a third channel section 323. The first channel section 321 is preferably hexagonal, and is formed with a first receiving hole 324 for receiving a movable first ball 326 which is partially protruded outward from the first receiving hole 324 without detachment. The second channel section 322 is preferably hexagonal, and is formed with a second receiving hole 325 for receiving a movable second ball 327 which is partially protruded outward from the second receiving hole 325 without detachment.

The sleeve 31 of the quick clamping head 3 is movably mounted on an outer wall of the main body 32. The sleeve 31 of the quick clamping head 3 has an inner wall formed with a first annular groove 311 alignable with the first receiving hole 324 of the main body 32 and a second annular groove 312 alignable with the second receiving hole 325 of the main body 32. Thus, when the first annular groove 311 of the sleeve 31 aligns with the first receiving hole 324 of the main body 32 and the second annular groove 312 of the sleeve 31 aligns with the second receiving hole 325 of the main body 32, the first ball 326 is inserted into the first annular groove 311 of the sleeve 31 and the second ball 327 is inserted into the second annular groove 312 of the sleeve 31.

A snap ring 34 is secured on the outer wall of the main body 32. A spring 33 is mounted between the sleeve 31 and the main body 32. The spring 33 is mounted on the outer wall of the main body 32 and is urged between the inner wall of the sleeve 31 and the snap ring 34. A snap cover 35 is secured on the inner wall of the sleeve 31 and is rested on the snap ring 34, so that the sleeve 31 is integrally combined with the main body 32 by engagement of the snap cover 35 with the snap ring 34, thereby preventing the sleeve 31 from detaching from the main body 32.

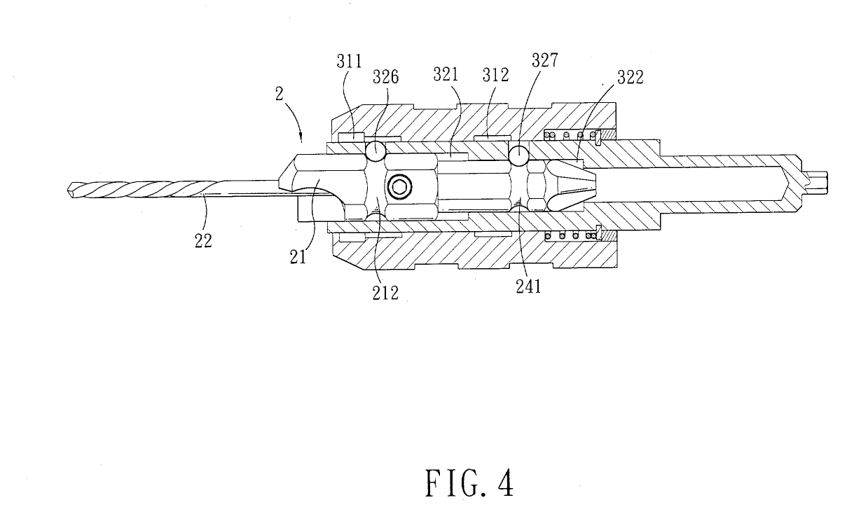

As shown in FIG. 4, the first ball 326 is inserted into the first locking groove 212 of the tool 2 and the second ball 327 is inserted into is inserted into the second locking groove 241 of the tool 2, so that the chamfered portion 21 and the drilling head 22 of the tool 2 protrude outward from the quick clamping head 3 for use.

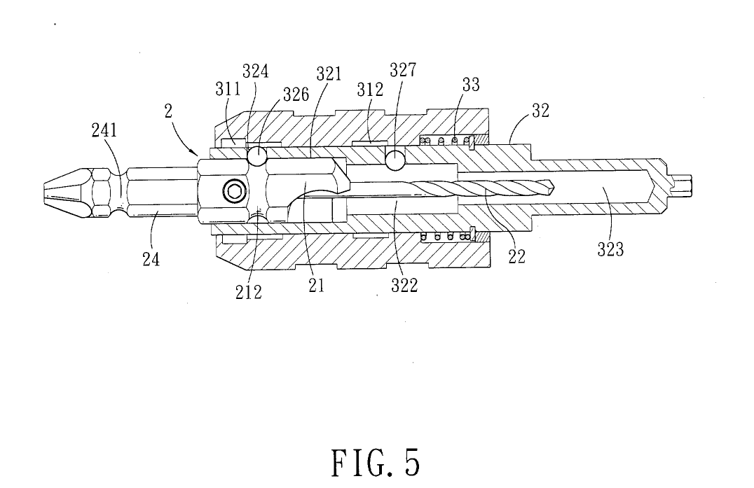

As shown in FIG. 5, the first ball 326 is inserted into the first locking groove 212 of the tool 2, so that the locking portion 24 of the tool 2 protrudes outward from the quick clamping head 3 for use.

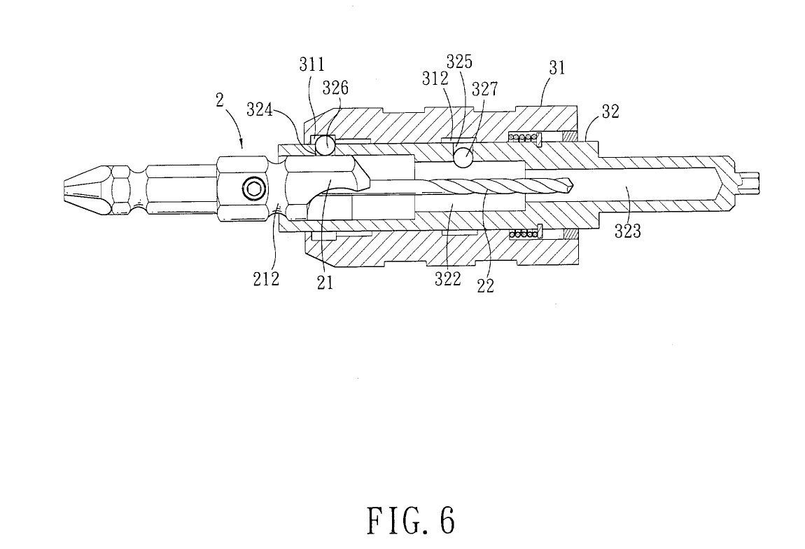

In operation, referring to FIGS. 5 and 6, the sleeve 31 is axially moved on the main body 32 to the position as shown in FIG. 6 where the first annular groove 311 of the sleeve 31 aligns with the first receiving hole 324 of the main body 32 and the second annular groove 312 of the sleeve 31 aligns with the second receiving hole 325 of the main body 32, so that the first ball 326 can be detached from the first channel section 321 and inserted into the first annular groove 311 of the sleeve 31 and the second ball 327 can be detached from the second channel section 322 and inserted into the second annular groove 312 of the sleeve 31.

Then, as shown in FIG. 5, the tool 2 is inserted into the receiving channel of the main body 32, so that the chamfered portion 21 of the tool 2 is inserted into the first channel section 321 of the main body 32 with the first locking groove 212 of the tool 2 aligning with the first receiving hole 324 of the main body 32, and the drilling head 22 of the tool 2 is inserted into the second channel section 322 and the third channel section 323 of the main body 32.

Then, the force applied on the sleeve 31 is removed, so that the sleeve 31 is returned to the original position by the restoring force of the spring 33. At this time, the first ball 326 is pressed by the inner wall of the sleeve 31 to be inserted into the first locking groove 212 of the tool 2, so that the tool 2 is locked and positioned on the quick clamping head 3, and the locking portion 24 of the tool 2 protrudes outward from the quick clamping head 3 for use as shown in FIG. 5.

In such a manner, as shown in FIG. 5 the locking portion 24 of the tool 2 protrudes outward from the quick clamping head 3, so that the tool 2 can be used to operate and lock a workpiece, such as a screw or the like. In addition, as shown in FIG. 4, the chamfered portion 21 and the drilling head 22 of the tool 2 protrude outward from the quick clamping head 3, so that the tool 2 can be used to perform the chamfering and drilling work.

Accordingly, the tool 2 co-operates with the quick clamping head 3 to perform the locking, chamfering and drilling work, thereby facilitating the user operating the tool, and thereby enhancing the working efficiency.

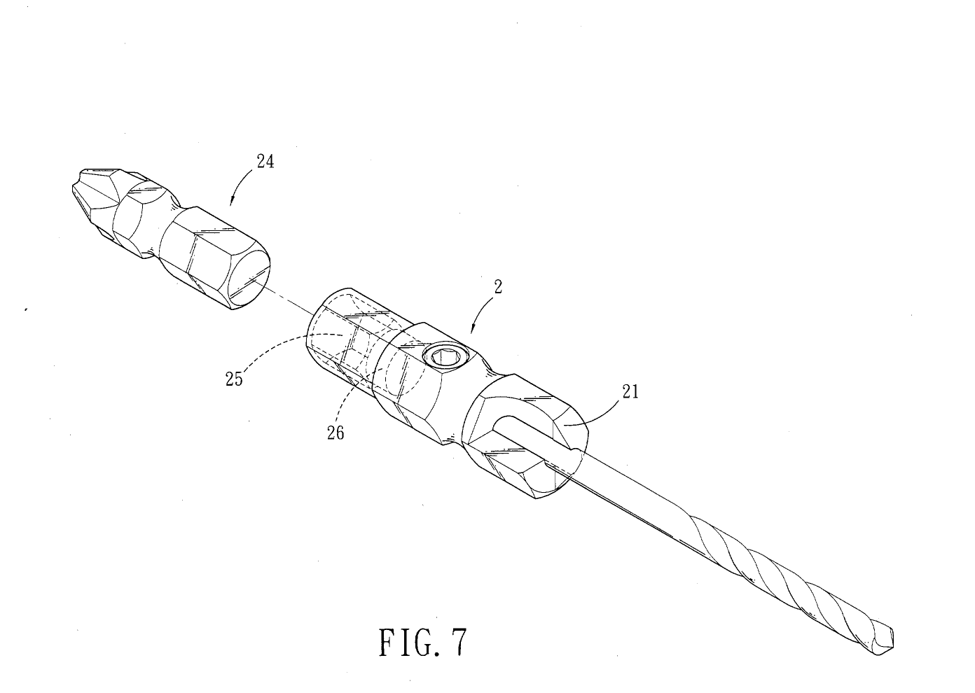

Referring to FIG. 7, a tool structure having drilling, chamfering and locking functions in accordance with another embodiment of the present invention is shown, wherein the locking portion 24 is detachably mounted on the tool 2. The second end of the tool 2 has an inner wall formed with a receiving socket 25 for receiving the locking portion 24, and a magnet 26 is mounted in the receiving socket 25 for attracting the locking portion 24 which is made of a magnetic material. Thus, the locking portion 24 is detachably mounted on the tool 2.

While the preferred embodiment(s) of the present invention has been shown and described, it will be apparent to those skilled in the art that various modifications may be made in the embodiment(s) without departing from the spirit of the present invention. Such modifications are all within the scope of the present invention.

What is claimed is:

1. A tool structure having drilling, chamfering and locking functions, comprising a quick clamping head, and a tool mounted on the quick clamping head, wherein:
the tool has a first end formed with a chamfered portion, the tool includes a drilling head secured on the chamfered portion, the tool has a second end formed with a locking portion;
the chamfered portion and the drilling head of the tool are detachably mounted on the quick clamping head; and
the locking portion of the tool is detachably mounted on the quick clamping head.

2. The tool structure having drilling, chamfering and locking functions in accordance with claim 1, wherein the chamfered portion of the tool has a center formed with an axially extended receiving recess for receiving the drilling head.

3. The tool structure having drilling, chamfering and locking functions in accordance with claim 2, wherein the drilling head has a first end formed with an operation portion protruding outward from the chamfered portion and a second end formed with an insertion portion inserted into the receiving recess.

4. The tool structure having drilling, chamfering and locking functions in accordance with claim 3, wherein the chamfered portion of the tool has a periphery formed with a fixing hole communicated with the receiving recess, and the tool further includes a positioning member secured in the fixing hole and urged on the insertion portion of the drilling head, thereby positioning the drilling head on the chamfered portion.

5. The tool structure having drilling, chamfering and locking functions in accordance with claim 1, wherein the chamfered portion of the tool has an outer wall formed with an annular first locking groove, and the locking portion of the tool has an outer wall formed with an annular second locking groove.

6. The tool structure having drilling, chamfering and locking functions in accordance with claim 1, wherein the quick clamping head includes a main body, and a sleeve movably mounted on the main body.

7. The tool structure having drilling, chamfering and locking functions in accordance with claim 6, wherein the main body of the quick clamping head has an inner wall formed with a step-shaped receiving channel, so that the tool is dual-directionally and interchangeably mounted on the quick clamping head.

8. The tool structure having drilling, chamfering and locking functions in accordance with claim 7, wherein the receiving channel of the main body of the quick clamping head has a first channel section, a second channel section, and a third channel section, the first channel section is formed with a first receiving hole for receiving a movable first ball which is partially protruded outward from the first receiving hole without detachment, and the second channel section is formed with a second receiving hole for receiving a movable second ball which is partially protruded outward from the second receiving hole without detachment.

9. The tool structure having drilling, chamfering and locking functions in accordance with claim 8, wherein the sleeve of the quick clamping head is movably mounted on an outer wall of the main body and has an inner wall formed with a first annular groove alignable with the first receiving hole of the main body and a second annular groove alignable with the second receiving hole of the main body.

10. The tool structure having drilling, chamfering and locking functions in accordance with claim 6, wherein the quick clamping head further includes a snap ring secured on the outer wall of the main body, and a spring mounted between the sleeve and the main body.

11. The tool structure having drilling, chamfering and locking functions in accordance with claim 10, wherein the spring is mounted on the outer wall of the main body and is urged between the inner wall of the sleeve and the snap ring.

12. The tool structure having drilling, chamfering and locking functions in accordance with claim 10, wherein the quick clamping head further includes a snap cover secured on the inner wall of the sleeve and rested on the snap ring, so that the sleeve is integrally combined with the main body by engagement of the snap cover with the snap ring, thereby preventing the sleeve from detaching from the main body.
